(19) United States
(12) Patent Application Publication
(10) Pub. No.: US 2005/0116649 A1
(43) Pub. Date: Jun. 2, 2005

(54) Low-pressure mercury vapor discharge lamp

(76) Inventors: Adrianus Johannes Hendricus Petrus Van Der Pol, Roosendaal (NL); Leonie Maria Geerdinck, Eindhoven (NL); Stefanus Petrus Wilhelmus Carton, Eindhoven (NL); Cornelia Titia Staats, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/510,297

(22) PCT Filed: Mar. 7, 2003
(86) PCT No.: PCT/IB03/00853

(30) Foreign Application Priority Data
Apr. 11, 2002 (EP) 02076441.1

(51) Int. Cl. H01J 17/16; H01J 61/30

(52) U.S. Cl. 313/635; 313/636; 313/637

(57) ABSTRACT

Low-pressure mercury vapor discharge lamp provided with a discharge vessel (10) which encloses enclosing a discharge space (11) provided with a filling of mercury and a rare gas in a gastight manner. The inner wall of the discharge vessel (10) is provided with a transparent layer (16) and a luminescent layer (17). According to the invention, the luminescent layer (17) is provided with a further transparent layer (18). Preferably, both transparent layers (16, 18) comprise an oxide of scandium, yttrium, or a further rare-earth metal, and/or a borate or phosphate of an alkaline-earth metal, and/or of scandium, yttrium, or a further rare-earth metal. Preferably, the alkaline-earth metal is calcium, strontium, and/or barium. The further rare-earth metal is preferably lanthanum, cerium, and/or gadolinium. The oxide is preferably Y2O3 or Gd2O3. The lamp according to the invention has a comparatively low mercury consumption.

The invention relates to a low-pressure mercury vapor discharge lamp comprising a discharge vessel,
the discharge vessel enclosing, in a gastight manner, a discharge space provided with a filling of mercury and a rare gas,
the discharge vessel comprising discharge means for maintaining a discharge in the discharge space,
while at least a portion of an inner wall of the discharge vessel is provided with a transparent layer, and
a side of the transparent layer facing the discharge space is provided with a luminescent layer comprising a luminescent material.

The invention also relates to a compact fluorescent lamp.

In mercury vapor discharge lamps, mercury constitutes the primary component for the (efficient) generation of ultraviolet (UV) light. A luminescent layer comprising a luminescent material (for example a fluorescence powder) converts UV to other wavelengths, for example to UV-B and UV-A for tanning purposes (sun panel lamps) or to visible radiation for general illumination purposes. Such discharge lamps are therefore also referred to as fluorescent lamps. The discharge vessel of low-pressure mercury vapor discharge lamps is usually circular and comprises both elongate and compact embodiments. Generally, the tubular discharge vessel of compact fluorescent lamps comprises a collection of relatively short straight parts having a relatively small diameter, which straight parts are connected together by means of bridge parts or via bent parts. Compact fluorescent lamps are usually provided with an (integrated) lamp cap.

It is known that measures are taken in low-pressure mercury vapor discharge lamps to inhibit blackening of portions of the inner wall of the discharge vessel, which portions are in contact with the discharge which, during operation of the lamp, is present in the discharge space. Such a blackening, which arises from an interaction of mercury and glass, is undesirable and does not only give rise to a lower light output but also gives the lamp an unaesthetic appearance, particularly because the blackening occurs irregularly, for example in the form of dark stains or dots. A transparent layer can be used to protect the inner wall of the discharge vessel.

A low-pressure mercury vapor discharge lamp of the type described in the opening paragraph is known from U.S. Pat. No. 4,544,997. In the known discharge lamp, an oxide of a metal selected from the group formed by yttrium, scandium, lanthanum, gadolinium, ytterbium, and lutetium is used as the transparent layer. The oxide is provided as a thin layer on the inner wall of the discharge vessel. Such transparent layers are colorless, hardly absorb UV radiation or visible light, and satisfy the requirements with respect to light and radiation transmissivity. Said transparent layer provides a protection against the reaction between Hg and the inner wall of the discharge vessel.

A drawback of the use of the known low-pressure mercury vapor discharge lamp is that the consumption of mercury is still relatively high. As a result, a relatively large amount of mercury is necessary for the known lamp in order to realize a sufficiently long lifetime. In the case of injudicious processing after the end of the lifetime, this is detrimental to the environment.

It is an object of the invention to eliminate the above disadvantage wholly or partly. In particular, it is an object of the invention to provide a low-pressure mercury vapor discharge lamp which consumes a relatively small amount of mercury. According to the invention, a low-pressure mercury vapor discharge lamp of the kind mentioned in the opening paragraph is for this purpose characterized in that a side of the luminescent layer facing the discharge space is provided with a further transparent layer.

A discharge vessel of a low-pressure mercury vapor discharge lamp according to the invention having a transparent layer and a further transparent layer is found to be very well resistant to the action of the mercury and rare gas atmosphere which, in operation, prevails in the discharge vessel. As a result, blackening due to interaction between mercury and the glass from which the discharge vessel is manufactured is considerably reduced, resulting in an improvement of lumen maintenance. During the service life of the discharge lamp, a smaller quantity of mercury is withdrawn from the discharge, so that, in addition, a reduction of the mercury consumption of the discharge lamp is obtained, and a smaller mercury dose will suffice in the manufacture of the low-pressure mercury vapor discharge lamp.

The discharge vessel of the low-pressure mercury vapor discharge lamp according to the invention is provided with a transparent layer between the inner wall of the discharge vessel and the luminescent layer, which layer is also referred to as a “pre-coat” layer, as well as with a further transparent layer on top of the fluorescent layer, which layer is also referred to as a “post-coat” layer. The combination of the pre-coat layer and the post-coat layer effectively protects the (glass of the) inner wall of the discharge vessel against the reaction with Hg. An advantage of applying two transparent layers with another layer in-between, in this case the luminescent layer, is that, if there is a limit to the thickness of the transparent layer, it is now possible to obtain an overall thicker protective layer by the measure of the invention.

The discharge vessel of the low-pressure mercury vapor discharge lamp according to the invention is provided with two protective layers which reduce the probability that mercury ions are absorbed by the wall of the discharge vessel. As a consequence, wall blackening is reduced. In this manner it becomes possible to manufacture a long-life low-pressure mercury vapor discharge lamp with, in operation, a somewhat unsaturated mercury pressure. In a so-called unsaturated low-pressure mercury vapor discharge lamp the amount of mercury dosed into the discharge vessel of the low-pressure mercury vapor discharge lamp is lower than the amount of mercury needed for a saturated mercury vapor pressure at nominal operation of the discharge lamp. Such an unsaturated mercury discharge lamp has the additional advantage that the burden on the environment is reduced.

An additional advantage of the use in low-pressure mercury vapor discharge lamps of a transparent layer and a further transparent layer according to the invention is that such layers have a relatively high reflectivity in the wavelength range around 254 nm (mercury generates, inter alia, resonance radiation at a wavelength of 254 nm in the discharge vessel). Given the refractive index of the transparent layer, which is relatively high with respect to the refractive index of the inner wall of the discharge vessel, such a layer thickness is preferably chosen such that the reflectivity at said wavelength is a maximum. The initial light output of low-pressure mercury vapor discharge lamps is increased by the use of such transparent layers.

An advantage of the use of the transparent layer according to the invention in low-pressure mercury vapor discharge lamps is that the luminescent layer comprising a luminescent material (for example a fluorescence powder) exhibits a good adhesion to such a transparent layer. In addition, the further transparent layer shows a good adhesion to the fluorescent layer.

A preferred embodiment of the low-pressure mercury vapor discharge lamp according to the invention is characterized in that the transparent layer and the further transparent layer comprise a material selected from the group formed by oxides of scandium, yttrium, and a further rare-earth metal, and/or a material selected from the group formed by borates of an alkaline-earth metal, scandium, yttrium, and a further rare-earth metal, and/or a material selected from the group formed by phosphates of an alkaline-earth metal, scandium, yttrium, and a further rare-earth metal.

Transparent layers comprising the oxides, borates and/or phosphates according to this embodiment of the invention are found to be very well resistant to the effect of the mercury and rare gas atmosphere which, in operation, prevails in the discharge vessel of a low-pressure mercury vapor discharge lamp. It has surprisingly been found that the mercury consumption of low-pressure mercury vapor discharge lamps provided with a transparent layer and a further transparent layer comprising said oxides, borates and/or phosphates is considerably lower than with transparent layers of the known low-pressure mercury vapor discharge lamp. By way of example, low-pressure mercury vapor discharge lamps provided with a transparent layer and a further transparent layer comprising said oxides, borates and/or phosphates were compared with known low-pressure mercury vapor discharge lamps provided with a (single) transparent layer comprising an oxide. After several thousands of operating hours, at least substantially half the mercury content was found in the transparent layers according to the embodiment of the invention as compared with the known (single) transparent layer. This effect occurs both in straight parts and in bent parts of (tubular) discharge vessels of low-pressure mercury vapor discharge lamps. Bent lamp parts are used, for example, in hook-shaped low-pressure mercury vapor discharge lamps. The measure according to the invention is notably suitable for (compact) fluorescent lamps having bent lamp parts.

The transparent layer and the further transparent layer in the low-pressure mercury vapor discharge lamp according to the invention further satisfy the requirements of light and radiation transmissivity. The transparent layer can be easily provided as a relatively thin, closed, and homogeneous layer on the inner wall of a discharge vessel of a low-pressure mercury vapor discharge lamp. Said transparent layer may be manufactured, for example, by rinsing the discharge vessel with a solution of a mixture of suitable metal-organic compounds (for example acetonates or acetates, for example scandium acetate, yttrium acetate, lanthanum acetate, or gadolinium acetate mixed with calcium acetate, strontium acetate, or barium acetate) or of boric acid or of phosphoric acid diluted in water, whereupon the desired layer is obtained after drying and sintering. The further transparent layer may be provided in a similar manner after the fluorescent layer has been provided in the discharge vessel of a low-pressure mercury vapor discharge lamp.

In a preferred embodiment of the low-pressure mercury vapor discharge lamp according to the invention, the alkaline-earth metal is calcium, strontium, and/or barium. A transparent layer or a further transparent layer with said alkaline-earth metals has a relatively high coefficient of transmission for visible light. Moreover, low-pressure mercury vapor discharge lamps with transparent layers comprising calcium borate or phosphate, strontium borate or phosphate, or barium borate or phosphate have a good lumen maintenance.

In a further preferred embodiment of the low-pressure mercury vapor discharge lamp according to the invention, the further rare-earth metal is lanthanum, cerium and/or gadolinium. A transparent layer or a further transparent layer with said rare-earth metals has a relatively high coefficient of transmission for ultraviolet radiation and visible light. It has further been found that such transparent layers have a good adhesion to the inner wall of the discharge vessel as well as to the fluorescent layer. Moreover, the layer can be provided in a relatively simple manner (for example with lanthanum acetate, cerium acetate, or gadolinium acetate mixed with boric acid or dilute phosphoric acid), which has a cost-saving effect, notably in a mass manufacturing process for low-pressure mercury vapor discharge lamps.

An additional advantage of the use of transparent layers comprising a borate and/or a phosphate of scandium, yttrium, lanthanum, cerium, and/or gadolinium in low-pressure mercury vapor discharge lamps is that such layers have a relatively high reflectivity in the wavelength range around 254 nm. By using said high-refractive transparent layers and by optimizing the layer thickness of such layers, a low-pressure mercury vapor discharge lamp having an increased initial light output is obtained. Such layers may be used to particular advantage in, for example, low-pressure mercury vapor discharge lamps for irradiation purposes (also referred to as germicide lamps).

The transparent layer and the further transparent layer in a low-pressure mercury vapor discharge lamp according to the invention preferably comprise an oxide of yttrium and/or gadolinium. Such transparent layers have a relatively high coefficient of transmission for ultraviolet radiation and visible light. It has further been found that layers comprising said oxides are low-hygroscopic and have a good adhesion to the inner wall of the discharge vessel and to the fluorescent layer. Moreover, the layers can be provided in a relatively easy manner (for example with yttrium acetate or gadolinium acetate), which has an additional cost-saving effect.

In practical embodiments of the low-pressure mercury vapor discharge lamp, said transparent layer and said further transparent layer have a thickness of approximately 5 μm to approximately 200 nm. At a layer thickness of more than 200 nm, there is a too large absorption of the radiation generated in the discharge space. At a layer thickness of less than 5 nm, there is interaction between the discharge and the wall of the discharge vessel. Layer thicknesses of at least substantially 90 nm are particularly suitable. At such layer thicknesses, the transparent layer has a relatively high reflectivity in the wavelength range around 254 nm.

A further preferred embodiment of the low-pressure mercury vapor discharge lamp according to the invention is characterized in that the discharge vessel is made from a glass comprising silicon dioxide and sodium oxide, with a glass composition comprising the following essential constituents, given in percentages by weight: 60-80% SiO₂ and 10-20% Na₂O. A discharge vessel of a low-pressure mercury vapor discharge lamp having the above glass composition and comprising a transparent layer and a further transparent layer is found to be very well resistant to the action of the mercury and rare gas atmosphere. In addition, the glass is comparatively inexpensive. A so-called mixed alkali glass having a comparatively low SiO₂ content is used in the known discharge lamp. The cost price of said glass is comparatively high. A comparison between the compositions of the known glass and the glass in accordance with the invention shows that the alkali content is different. The glass in accordance with the invention is a so-called sodium-rich glass with a comparatively low potassium content, whereas the known glass is a so-called mixed alkali glass having an approximately equal molar ratio of Na₂O and K₂O. An advantage is that the mobility of the alkali ions in the sodium-rich glass is comparatively high with respect to the mobility in the mixed alkali glass. In addition, melting sodium-rich glass is comparatively easier than melting mixed alkali glass.

The glass composition preferably comprises the following constituents: 70-75% SiO₂, 15-18% Na₂O, and 0.25-2% K₂O by weight. The composition of such a sodium-rich glass is similar to that of ordinary window glass and it is comparatively cheap with respect to the glass used in the known discharge lamp. The cost price of the raw materials for the sodium-rich glass as used in the discharge lamp in accordance with the invention is only approximately 75% of the cost price of the raw materials for the mixed alkali glass as used in the known discharge lamp. Moreover, the conductivity of said sodium-rich glass is comparatively low; at 250° C. the conductivity is approximately log ρ=6.3 whereas the corresponding value of the mixed alkali glass is approximately log ρ=8.9.

These and other aspects of the invention are apparent from and will be elucidated with reference to the embodiments described hereinafter.

In the drawings:

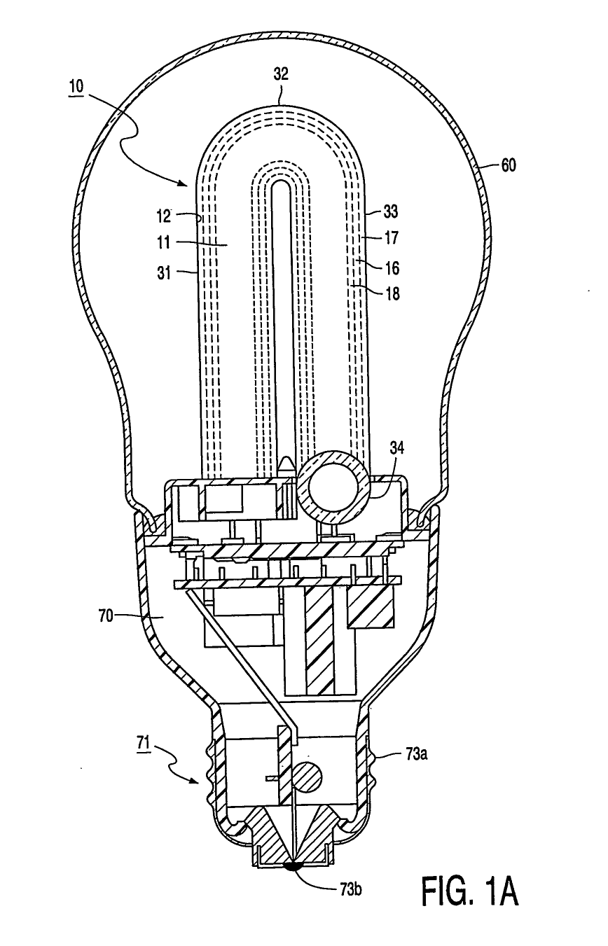

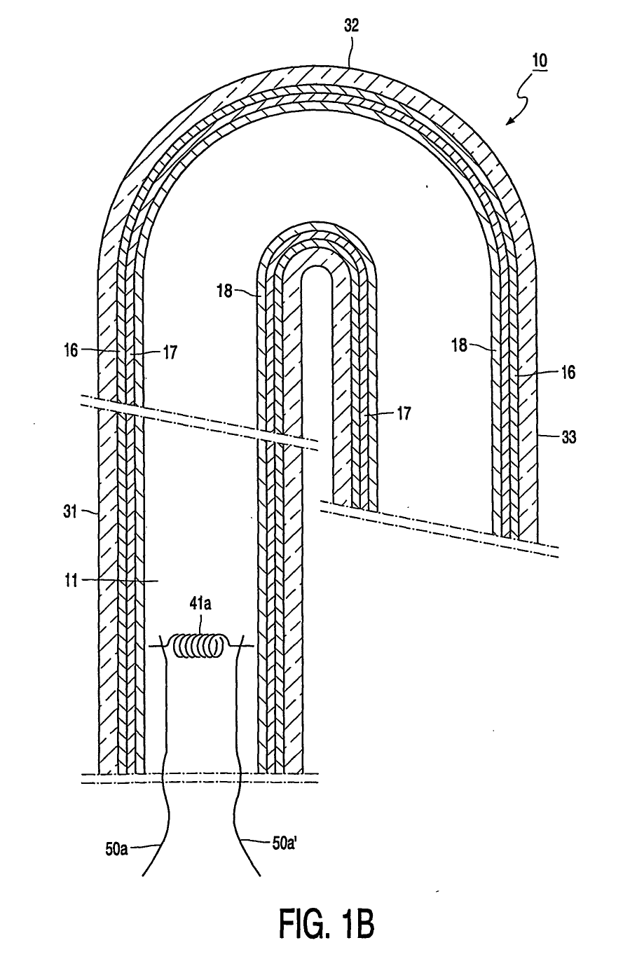

FIG. 1A is a side elevation of an embodiment of the low-pressure mercury vapor discharge lamp according to the invention, and

FIG. 1B is a cross-section of a detail of the low-pressure mercury vapor discharge lamp as shown in FIG. 1A.

The Figures are purely diagrammatic and not drawn to scale. Notably, some dimensions are shown in a strongly exaggerated form for the sake of clarity. Similar components in the Figures are denoted by the same reference numerals as much as possible.

FIG. 1A shows a low-pressure mercury vapor discharge lamp provided with a radiation-transmissive discharge vessel 10 enclosing, in a gastight manner, a discharge space 11 having a volume of approximately 30 cm³. The discharge vessel 10 is a (lime) glass tube having an at least substantially circular cross-section with an (effective) internal diameter of approximately 10 mm. The tube is bent in the form of a hook and, in this embodiment, it has a number of straight parts, two of which, referenced 31, 33, are shown in FIG. 1A. The discharge vessel further comprises a number of arcuate parts, two of which, referenced 32, 34, are shown in FIG. 1A. An inner wall 12 of the discharge vessel 10 is provided with a transparent layer 16 according to the invention, with a luminescent layer 17, and with a further transparent layer 18 according to the invention. The discharge vessel 10 is supported by a housing 70 which also supports a lamp cap 71 provided with electrical and mechanical contacts 73a, 73b, which are known per se. The discharge vessel 10 of the low-pressure mercury-vapor discharge lamp is surrounded by a light-transmitting envelope 60 which is attached to the lamp housing 70. The light-transmitting envelope 60 generally has a matt appearance.

FIG. 1B is a highly diagrammatic cross-sectional view of a detail of the low-pressure mercury-vapor discharge lamp shown in FIG. 1A. The discharge space 11 in the discharge vessel 10 does not only comprise mercury but also a rare gas, argon in this example. Means for maintaining a discharge are constituted by an electrode pair 41a (only one electrode is shown in FIG. 1B) which is arranged in the discharge space 11. Each electrode of the pair 41a is a winding of tungsten coated with an electron-emissive material, here a mixture of barium oxide, calcium oxide, and strontium oxide. Each electrode 41a is supported by an (indented) end portion of the discharge vessel 10 (not shown in FIGS. 1A and 1B). Current supply conductors 50a, 50a′ issue from the electrode pair 41a through the end portions of the discharge vessel 10 to the exterior. The current supply conductors 50a, 50a′ are connected to an (electronic) power supply which is accommodated in the housing 70 and electrically connected to the electrical contacts 73b at the lamp cap 71 (see FIG. 1A).

The glass of the discharge vessel of the low-pressure mercury-vapor discharge lamp has a composition that comprises silicon dioxide and sodium oxide as important constituents. In the example shown in FIGS. 1A and 1B, the discharge vessel in accordance with the invention is made from so-called sodium-rich glass. Particularly preferred is a glass of the following composition: 70-74% SiO2, 16-18% Na₂O, 0.5-1.3% K₂O, 4-6% CaO, 2.5-3.5% MgO, 1-2% Al₂O₃, 0-0.6% Sb₂O₃, 0-0.15% Fe₂O₃ and 0-0.05% MnO by weight.

In an embodiment of the low-pressure mercury vapor discharge lamp, various concentrations of an Me(Ac)₂ solution, in which Me=Sr or Ba, and H₃BO₃ were added to solutions comprising various concentrations of Y(Ac)₃ (yttrium acetate) for manufacturing the transparent layer 17. The molar ratio between Me(Ac)₂ and H₃BO₃ was kept constant. For the purpose of comparison, a solution with 1.25% by weight of Y(Ac)₃ was also prepared. After rinsing and drying, the tubular discharge vessels were provided with a coating by passing an excess of the aforementioned solutions through the vessels. After coating, the discharge vessels were dried in air at a temperature of approximately 70° C. Subsequently, the discharge vessels were provided with a luminescent coating comprising three known phosphates, namely a green-luminescing material with terbium-activated cerium-magnesium aluminate, a blue-luminescing material with bivalent europium-activated barium-magnesium aluminate, and a red-luminescing material with trivalent europium-activated yttrium oxide. In a similar fashion as the transparent layer 17, a further transparent layer 18 was provided on top of the luminescent layer 17. After coating, the discharge vessels were bent into the known hook shape with straight parts 31, 33 and arcuate parts 34 (see FIG. 1A). A number of discharge vessels was subsequently assembled into low-pressure mercury vapor discharge lamps in the customary manner.

The adhesion of the transparent layer 17 to the inner wall 12 of the discharge vessel 10, the adhesion of the luminescent layer 17 to the transparent layer 17, and the adhesion of the further transparent layer 18 to the luminescent layer 17 of a number of the discharge vessels thus manufactured was examined, using a test referred to as “clapper test”. The result is shown in Table I.

TABLE I
Adhesion in discharge vessels (Ecotone Ambiance 20 W) with and
without a transparent layer and a further transparent layer.

| | Y(Ac)₃ | Sr(Ac)₂ | H₃BO₃ | “powder- |
|---|---|---|---|---|
| | % by weight | (mole) | (mole) | off” |
| 1 | — | — | — | 2 |
| 2 | 1.25 | — | — | 5 |
| 3 | 1.25 | 0.028 | 0.11 | 3 |
| 4 | 1.25 | 0.028 | 0.11 | 1 |

The “powder-off” column 5 of Table I relates to a scale ranging from 0=“no powder-off” (excellent adhesion) to 10=“all powder-off” (no adhesion). Row 1 shows the result of a luminescent layer provided directly on the inner wall of the discharge vessel. Row 2 shows the result of a transparent layer (only comprising Y₂O₃) of the known discharge lamp. Row 3 of Table I shows the result of the combination of a transparent layer on top of a luminescent layer. Row 4 of Table I shows the result of the combination of a transparent layer on the inner wall of the discharge vessel, a luminescent layer on top of said transparent layer, and a further transparent layer on the luminescent layer of low-pressure mercury vapor discharge lamps according to the invention. Table I shows that the adhesion of the transparent layer, the luminescent layer, and the further transparent layer to the inner wall of the discharge vessel and to each other is comparable to or better than that of an uncoated discharge lamp and is considerably better than the adhesion of the luminescent layer to a transparent layer of the known discharge lamp.

Table II shows the results of lumen maintenance tests.

TABLE II
Maintenance of discharge lamps (TL5 54 W) with and without a
transparent layer and a further transparent layer.

| | Y(Ac)₃ | | | Maintenance | | |
|---|---|---|---|---|---|---|
| | % by | Sr(Ac)₂ | H₃BO₃ | Lumens | 100 hrs | 1000 hrs |
| | weight | (mole) | (mole) | 100 hrs | (%) | (%) |
| 1 | — | — | — | 4800 | 100 | 90 |
| 2 | 1.25 | — | — | 5000 | 100 | 98 |
| 3 | 1.25 | 0.028 | 0.11 | 4700 | 100 | 94 |
| 4 | 1.25 | 0.028 | 0.11 | 4700 | 100 | 99 |

Table II shows that the maintenance of low-pressure mercury vapor discharge lamps (TL5 54W) provided with a transparent layer and a further transparent layer according to the invention is improved with respect to the known discharge lamp and with respect to the uncoated discharge lamp. Comparable tests, in which Ba(Ac)₂ instead of Sr(Ac)₂ was used as a precursor for the transparent layer, show that the maintenance of these discharge lamps is comparable to that of the known discharge lamp, but the discharge lamps having a Ba addition according to the invention have an improved adhesion of the luminescent layer to the transparent layer.

Table II shows, by way of example, the result of the mercury consumption (expressed in μg Hg) of various low-pressure mercury vapor discharge lamps (Ecotone Ambiance 20 W). The example of Table III relates to a low-pressure mercury vapor discharge lamp as shown in FIGS. 1A and 1B with a transparent layer and a further transparent layer comprising Sr, in which the tubular discharge vessel is bent into the shape of a hook and has four straight parts 31, 33 and three arcuate parts 34. The mercury contents (in μg Hg) of the transparent layer were (destructively) measured for six lamps after several thousands of operating hours. The values found for the mercury consumption were averaged. Table III does not state any results of measurements of the mercury consumption in the ambience of the electrode and/or amalgam.

TABLE III
Mercury consumption (in μg Hg) of various parts of discharge lamps
(Ecotone Ambiance 20 W) with and without a transparent layer.

| | |
|---|---|
| transparent layer | Hg consumption |

| | pre-coat | post-coat | straight parts | bent parts |
|---|---|---|---|---|
| 1 | no | no | 50 | 100 |
| 2 | Y₂O₃ | no | 10 | 40 |
| 3 | no | Y₂O₃ + Sr | 30 | 80 |
| | | borate | | |
| 4 | Y₂O₃ + Sr | Y₂O₃ + Sr | 5 | 10 |
| | borate | borate | | |

Table III shows that the mercury consumption is considerably lower in both the straight parts 31, 33 and the bent parts 34 of the discharge vessel than in discharge lamps without a transparent layer or in known discharge lamps. In the example of Table III, the transparent layer (pre-coat) and the further transparent layer (post-coat) comprise yttrium oxide and strontium borate. Roughly speaking, the mercury consumption is improved, i.e. reduced, by a factor of two, coming from a discharge lamp without a transparent layer to a discharge lamp provided with the known Y₂O₃ transparent layer, and the mercury consumption further improves by another factor of two, coming from a discharge lamp provided with the known Y₂O₃ transparent layer to a discharge lamp provided with a transparent layer and a further transparent layer according to the invention. Due to the measure according to the invention, the mercury consumption in, notably, the bent parts 34 of the discharge vessel is improved considerably. The latter is notably the case when relatively thick transparent layers are used because the discharge vessel is stretched by approximately 30% during bending, so that the transparent layer and the further transparent layer are thinner at the bent parts 34 than at the straight parts 31, 33 of the discharge vessel 10. It is to be noted that the color point of the low-pressure mercury vapor discharge lamp provided with transparent layers according to the invention satisfies the customary requirements (x≈0.31, y≈0.32).

It will be evident that many variations within the scope of the invention can be conceived by those skilled in the art.

The scope of the invention is not limited to the embodiments. The invention resides in each new characteristic feature and each combination of novel characteristic features. Any reference signs do not limit the scope of the claims. The word “comprising” does not exclude the presence of other elements or steps than those listed in a claim. Use of the word “a” or “an” preceding an element does not exclude the presence of a plurality of such elements.

1. A low-pressure mercury vapor discharge lamp comprising a discharge vessel (10),
the discharge vessel (10) enclosing, in a gastight manner, a discharge space (11) provided with a filling of mercury and a rare gas,
the discharge vessel (10) comprising discharge means for maintaining a discharge in the discharge space (11),
while at least a portion of an inner wall (12) of the discharge vessel (10) is provided with a transparent layer (16), and
a side of the transparent layer (16) facing the discharge space (11) is provided with a luminescent layer (17) comprising a luminescent material, characterized in that
a side of the luminescent layer (17) facing the discharge space (11) is provided with a further transparent layer (18).

2. A low-pressure mercury vapor discharge lamp as claimed in claim 1, characterized in that the transparent layer (16) and the further transparent layer (17) comprise
a material selected from the group formed by oxides of scandium, yttrium, and a further rare-earth metal, and/or
a material selected from the group formed by borates of an alkaline-earth metal, scandium, yttrium, and a further rare-earth metal, and/or
a material selected from the group formed by phosphates of an alkaline-earth metal, scandium, yttrium, and a further rare-earth metal.

3. A low-pressure mercury vapor discharge lamp as claimed in claim 1, characterized in that the alkaline-earth metal is calcium, strontium, and/or barium.

4. A low-pressure mercury vapor discharge lamp as claimed in claim 1, characterized in that the further rare-earth metal is lanthanum, cerium, and/or gadolinium.

5. A low-pressure mercury vapor discharge lamp as claimed in claim 3, characterized in that the oxide is yttrium oxide and/or gadolinium oxide.

6. A low-pressure mercury vapor discharge lamp as claimed in claim 1, characterized in that the transparent layer (16) and the further transparent layer (18) have a thickness of between 5 nm and 200 nm.

7. A low-pressure mercury vapor discharge lamp as claimed in claim 1, characterized in that the luminescent material comprises a mixture of green-luminescing, terbium-activated cerium-magnesium aluminate, blue-luminescing barium-magnesium aluminate activated by bivalent europium, and red-luminescing yttrium oxide activated by trivalent europium.

8. A low-pressure mercury vapor discharge lamp as claimed in claim 1, characterized in that the discharge vessel (10) is made from a glass comprising silicon dioxide and sodium oxide, with a glass composition comprising the following essential constituents, given in percentages by weight:

| | |
|---|---|
| SiO₂ | 60-80%, |
| Na₂O | 10-20%. |

9. A low-pressure mercury vapor discharge lamp as claimed in claim 8, characterized in that the glass composition includes the following constituents:

| | | |
|---|---|---|
| SiO₂ | 70-75% | by weight |
| Na₂O | 15-18% | by weight |
| K₂O | 0.25-2%. | by weight |

10. A compact fluorescent lamp comprising a low-pressure mercury-vapor discharge lamp as claimed in claim 1, characterized in that a lamp housing (70) is attached to the discharge vessel (10) of the low-pressure mercury-vapor discharge lamp, which lamp housing is provided with a lamp cap (71).

11. A compact fluorescent lamp as claimed in claim 10, characterized in that the discharge vessel (10) of the low-pressure mercury-vapor discharge lamp is surrounded by a light-transmitting envelope (60) which is attached to the lamp housing (70).
